(19) United States
(12) Patent Application Publication
(10) Pub. No.: US 2024/0101825 A1
(43) Pub. Date: Mar. 28, 2024

(54) GREASE COMPOSITION AND ROLLING BEARING

(71) Applicant: JTEKT CORPORATION, Kariya-shi, Aichi (JP)

(72) Inventors: Yurie HAGINO, Kashihara-shi (JP); Takeshi TSUDA, Kashiba-shi (JP)

(73) Assignee: JTEKT CORPORATION, Kariya-shi, Aichi (JP)

(21) Appl. No.: 17/641,372

(22) PCT Filed: Sep. 15, 2020
(86) PCT No.: PCT/JP2020/034927

§ 371 Date: Nov. 15, 2023

(30) Foreign Application Priority Data
Sep. 18, 2019 (JP) 2019-169660
May 18, 2020 (JP) 2020-086755

(51) Int. Cl. C08L 91/00; C08K 3/34; C08K 5/21

(52) U.S. Cl. CPC C08L 91/00; C08K 3/346; C08K 5/21; C08K 2201/001; C08K 2201/012

(57) ABSTRACT

A grease composition contains a base oil, a thickener, and a conductive additive (A), the base oil is a trimellitic acid ester, the conductive additive (A) is a mixture containing sepiolite and bentonite and is an organically modified additive, and an amount of the conductive additive (A) with respect to a total amount of the base oil, the thickener, and the conductive additive (A) is 3 to 10 mass %.

### TECHNICAL FIELD

The present disclosure relates to a grease composition and a rolling bearing in which the grease composition is enclosed.

### BACKGROUND ART

In recent years, countermeasures against electrolytic corrosion in motor beatings have been required with an increase in demand for EV vehicles and hybrid vehicles.

For example, in order to provide a rolling bearing that is less likely to cause electrification or electrolytic corrosion due to conductivity and that is less likely to cause leak of a grease composition, PATENT LITERATURE 1 proposes a conductive grease composition containing a synthetic hydrocarbon oil and specific three types of carbon blacks as a conductive additive.

### CITATION LIST

### Patent Literature

PATENT LITERATURE 1: Japanese Laid-Open Patent Publication No. 2006-329364

### SUMMARY OF THE INVENTION

A grease composition according to the present disclosure is a grease composition containing a base oil, a thickener, and a conductive additive (A), wherein
the base oil is a trimellitic acid ester,
the conductive additive (A) is a mixture containing sepiolite and bentonite and is an organically modified additive, and
an amount of the conductive additive (A) with respect to a total amount of the base oil, the thickener, and the conductive additive (A) is 3 to 10 mass %.

A rolling bearing according to the present disclosure is a rolling bearing in which the grease composition according to the present disclosure is enclosed.

### BRIEF DESCRIPTION OF DRAWINGS

FIG. 1 is a cross-sectional view showing a ball bearing according to an embodiment of the present disclosure.

FIG. 2 is a diagram for illustrating a base grease preparation step.

FIG. 3(a) is a schematic diagram of a bearing rotation torque measurement testing machine.

FIG. 3(b) is a cross-sectional view of a main part of FIG. 3(a).

FIG. 4 is a diagram for illustrating the relationship between rotation torque and lost energy (derived from rotation torque).

FIG. 5 is a schematic diagram of a bearing grease life measurement testing machine.

### DETAILED DESCRIPTION

### Problems to be Solved by the Invention of the Present Disclosure

A grease composition containing carbon black is black, so that when the grease composition leaks from a rolling bearing, the rolling bearing or a member around the rolling bearing may be stained in black, causing deterioration in appearance.

In addition, when carbon black is blended, an increase in torque may be caused.

The present inventors have conducted an intensive study under such circumstances, have found that a grease composition containing a specific base oil and conductive additive exhibits good conductivity, and can suppress an increase in torque of a rolling bearing when being enclosed in the rolling bearing, and have completed the invention of the present disclosure.

### Advantageous Effects of the Invention of the Present Disclosure

The grease composition according to the present disclosure has excellent conductivity, and the rolling bearing according to the present disclosure in which the grease composition is enclosed is less likely to cause electrolytic corrosion.

In addition, the grease composition according to the present disclosure is useful for reducing the torque of a rolling bearing.

### Outline of Embodiment of the Invention of the Present Disclosure

Hereinafter, the outlines of embodiments of the invention of the present disclosure are listed and described.

(1) A grease composition according to the present disclosure is a grease composition containing a base oil, a thickener, and a conductive additive (A), wherein
the base oil is a trimellitic acid ester,
the conductive additive (A) is a mixture containing sepiolite and bentonite and is an organically modified additive, and
an amount of the conductive additive (A) with respect to a total amount of the base oil, the thickener, and the conductive additive (A) is 3 to 10 mass %.

The above grease composition is a grease composition containing a base oil, a thickener, and a conductive additive (A), the base oil is a trimellitic acid ester, and the conductive additive (A) is a mixture containing sepiolite and bentonite and is an organically modified additive.

The grease composition containing such blending ingredients has good conductivity and thus can suppress occurrence of electrolytic corrosion in a rolling bearing in which the grease composition is enclosed. In addition, the grease composition can also contribute to reducing the torque of the rolling bearing in which the grease composition is enclosed.

(2) In the grease composition, a proportion of the thickener to a total mass of the base oil and the thickener is preferably 10 to 25 mass %.

(3) In the grease composition, the thickener is preferably a diurea represented by the following structural formula (1).

R¹—NHCONH—R²—NHCONH—R³ (1),

wherein R¹ and R³ are each independently a functional group represented by —CₙH₂ₙ₊₁ (n is an integer from 6 to 10), and R² is —(CH₂)₆—, —C₆H₃(CH₃)—, or —C₆H₄—CH₂—C₆H₄—.

This case is more suitable for reducing the torque of the rolling bearing in which the grease composition is enclosed.

(4) In the grease composition of the above (3), the proportion of the thickener to the total mass of the base oil and the thickener is preferably 15 to 25 mass %.

(5) In the grease composition, the thickener is preferably a mixture of a diurea represented by the following structural formula (2), a diurea represented by the following structural formula (3), and a diurea represented by the following structural formula (4).

R⁴—NHCONH—R⁵—NHCONH—R⁶ (2),

wherein R⁴ and R⁶ are each independently a functional group represented by —CₙH₂ₙ₊₁ (n is an integer from 6 to 10), and R⁵ is —(CH₂)₆—, —C₆H₃(CH₃)—, or —C₆H₄—CH₂—C₆H₄—.

R⁷—NHCONH—R⁸—NHCONH—R⁹ (3),

wherein R⁷ and R⁹ are each independently a cyclohexyl group or an alkylcyclohexyl group having 1 to 4 alkyl groups having 1 to 4 carbon atoms (the total number of carbon atoms of the alkyl groups is not greater than 4), and R⁸ is —(CH₂)₆—, —C₆H₃(CH₃)—, or —C₆H₄—CH₂—C₆H₄—.

R¹⁰—NHCONH—R¹¹—NHCONH—R¹² (4),

wherein R¹⁰ is a functional group represented by —CₙH₂ₙ₊₁ (n is an integer from 6 to 10), R¹² is a cyclohexyl group or an alkylcyclohexyl group having 1 to 4 alkyl groups having 1 to 4 carbon atoms (the total number of carbon atoms of the alkyl groups is not greater than 4), and R¹¹ is —(CH₂)₆—, —C₄H₃(CH₃)—, or —C₆H₄—CH₂—C₆H₄—.

This case is also more suitable for reducing the torque of the rolling bearing in which the grease composition is enclosed. In addition, this case is suitable for extending the time to the end of the grease life of the rolling bearing in which the grease composition is enclosed.

(6) In the thickener of the grease composition of the above (5), a proportion of a total amount of R⁴, R⁶, and R¹⁰ to a total amount of R⁴, R⁶, R¹⁰, R⁷, R⁹, and R¹² is preferably 50 to 90 mol %.

(7) In the grease composition of the above (5) or (6), the proportion of the thickener to the total mass of the base oil and the thickener is preferably 10 to 20 mass %.

(8) The grease composition of any of the above (1) to (7) preferably further contains at least a rust preventive or an antioxidant.

(9) A rolling bearing according to the present disclosure is a rolling bearing in which the grease composition of any of the above (1) to (8) is enclosed.

### Details of Embodiments of the Invention of the Present Disclosure

Hereinafter, embodiments of the invention of the present disclosure will be described with reference to the drawings.

In the present disclosure, the embodiments of the invention are merely illustrative in all aspects and should not be recognized as being restrictive. The scope of the present invention is defined by the scope of the claims, and is intended to include meaning equivalent to the scope of the claims and all modifications within the scope.

A rolling bearing according to an embodiment of the present disclosure is a ball bearing in which a grease composed of a grease composition according to an embodiment of the present disclosure is enclosed.

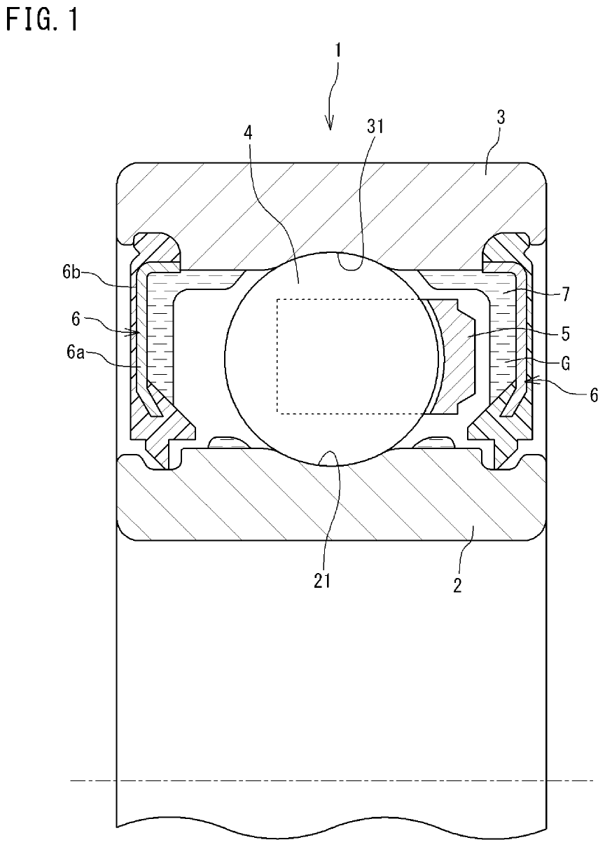

FIG. 1 is a cross-sectional view showing the ball bearing according to the embodiment of the present disclosure.

A ball bearing 1 includes an inner ring 2, an outer ring 3 which is provided radially outward of the inner ring 2, balls 4 as a plurality of rolling elements which are provided between the inner ring 2 and the outer ring 3, and an annular retainer 5 which retains these balls 4. In addition, in the ball bearing 1, a seal 6 is provided on each of one side and another side in the axial direction thereof.

Furthermore, a grease G composed of the grease composition according to the embodiment of the present disclosure is enclosed in an annular region 7 between the inner ring 2 and the outer ring 3.

The inner ring 2 has an inner raceway surface 21 which is formed on the outer circumference thereof and on which the balls 4 roll.

The outer ring 3 has an outer raceway surface 31 which is formed on the inner circumference thereof and on which the balls 4 roll.

The plurality of balls 4 are interposed between the inner raceway surface 21 and the outer raceway surface 31 and roll on the inner raceway surface 21 and the outer raceway surface 31.

The grease G enclosed in the region 7 is also provided at locations where the balls 4 and the inner raceway surface 21 of the inner ring 2 are in contact with each other and at locations where the balls 4 and the outer raceway surface 31 of the outer ring 3 are in contact with each other. The grease G is enclosed so as to occupy 20 to 40 vol % of the volume of a space obtained by excluding the balls 4 and the retainer 5 from a space surrounded by the inner ring 2, the outer ring 3, and the seals 6.

Each seal 6 is an annular member which includes an annular metal ring 6a and an elastic member 6b fixed to the metal ring 6a, and is mounted such that a radially outer portion thereof is fixed to the outer ring 3 and a lip tip of a radially inner portion thereof is slidable on the inner ring 2. Each seal 6 prevents the enclosed grease G from leaking to the outside.

In the ball bearing 1 configured as described above, the grease composed of the grease composition according to the embodiment of the present disclosure described later is enclosed as the grease G. Therefore, in the ball bearing 1 in which the grease G is enclosed, occurrence of electrolytic corrosion is suppressed and low-torque performance is ensured.

Next the grease composition forming the grease G will be described in detail.

The grease composition forming the grease G is the grease composition according to the embodiment of the present disclosure and contains a base oil, a thickener, and a conductive additive (A).

The base oil is a trimellitic acid ester. The trimellitic acid ester is suitable for imparting good conductivity to the grease G when used in combination with an organophilic phyllosilicate. In addition, using the trimellitic acid ester as the base oil is also suitable for imparting good heat resistance to the grease G.

The trimellitic acid ester is preferably a trimellitic acid triester.

Examples of the trimellitic acid triester include reaction products of trimellitic acid and a monoalcohol having 6 to 18 carbon atoms. Among them, a reaction product of trimellitic acid and a monoalcohol having 8 and/or 10 carbon atoms is preferable.

Specific examples of the trimellitic acid triester include tri-2-ethylhexyl trimellitate, tri-n-alkyl trimellitate (C8, C10), tri-isodecyl trimellitate, and tri-normaloctyl trimellitate.

Only one of the trimellitic acid triesters may be used, or two or more of the trimellitic acid triesters may be used in combination.

The base oil kinetic viscosity at 40° C. of the trimellitic acid triester is preferably 37 to 57 mm²/s. This case is suitable for reducing the torque of a rolling beating while ensuring heat resistance.

The base oil kinetic viscosity is a value measured according to JIS K 2283.

In the grease composition, the proportion of the thickener to the total mass of the base oil and the thickener is preferably 10 to 25 mass %.

If the amount of the thickener is less than 10 mass %, the ability to retain the base oil of the grease G may decrease, and the amount of the base oil separated from the grease G during rotation of the rolling bearing may become large. On the other hand, if the amount of the thickener exceeds 25 mass %, agitation resistance generated by shearing the grease G due to relative motion of the inner ring, the outer ring, the balls, and the retainer caused by rotation of the rolling bearing may become larger to increase the torque of the rolling bearing, or oxidation of the grease G due to heat generation of the grease G caused with agitation resistance generated by shearing the grease G and degradation of the grease G due to evaporation or separation of the base oil may be promoted.

As the thickener, for example, a urea-based thickener is used.

The thickener is preferably a diurea.

The diurea as the thickener is preferably a diurea represented by the following structural formula (1).

R¹—NHCONH—R²—NHCONH—R³ (1),

wherein R¹ and R³ are each independently a functional group represented by —CₙH₂ₙ₊₁ (n is an integer from 6 to 10), and R² is —(CH₂)—, —C₆H₃(CH₃)—, or —C₆H₄—CH₂—C₆H₄—.

Here, in the case where R² is —CH₃(CH₃)—, the phenylene group, bonded with the methyl group at the 1 position, is preferably bonded at the 2 and 4 positions or the 2 and 6 positions. In addition, in the case where R² is —CH₄—CH₂—C₆H₄—, both phenylene groups are preferably bonded at the para position.

R² is preferably —C₄H₄—CH₂—C₆H₄—.

The diurea represented by the structural formula (1) is an aliphatic diurea that has a short carbon chain length and in which R¹ and R³ are each an alkyl group having 6 to 10 carbon atoms. The grease composition in which such an aliphatic diurea is used has high viscosity-reducing energy, which is one index of channeling properties, and is suitable for torque reduction.

The viscosity-reducing energy is one index of thixotropy, and can be obtained by using a rotary rheometer.

The diurea represented by the structural formula (1) is a product produced by reaction between an aliphatic amine and a diisocyanate compound.

The aliphatic amine is an aliphatic amine having 6 to 10 carbon atoms, and specific examples of the aliphatic amine include 1-aminohexane, 1-aminoheptane, 1-aminooctane, I-aminononane, and 1-aminodecane.

Among them, 1-aminooctane is preferable.

Only one of the aliphatic amines may be used, or two or more of the aliphatic amines may be used in combination.

Examples of the diisocyanate compound include hexamethylene diisocyanate (HDI), 2,4-toluene diisocyanate (2,4-TDI), 2,6-toluene diisocyanate (2,6-TDI), a mixture of 2,4-TDI and 2,6-TDI, and 4,4′-diphenylmethane diisocyanate (MDI).

In order to obtain the diurea represented by the structural formula (1), the aliphatic amine and the diisocyanate compound can be reacted under various conditions. The aliphatic amine and the diisocyanate compound are preferably reacted in the base oil since a diurea compound having high uniform dispersibility as the thickener is obtained.

In addition, the reaction between the aliphatic amine and the diisocyanate compound may be carried out by adding a base oil in which the diisocyanate compound is dissolved, to a base oil in which the aliphatic amine is dissolved, or may be carried out by adding a base oil in which the aliphatic amine is dissolved, to a base oil in which the diisocyanate compound is dissolved.

The temperature and the time in the reaction between the aliphatic amine and the diisocyanate compound are not particularly limited, and conditions that are the same as the conditions usually used for such a reaction may be used.

The reaction temperature is preferably 150° C. to 170° C. from the viewpoint of solubility and volatility of the aliphatic amine and the diisocyanate compound.

The reaction time is preferably 0.5 to 2.0 hours from the viewpoint of completing the reaction between the aliphatic amine and the diisocyanate compound and from the viewpoint of shortening the production time to efficiently produce the grease composition.

In the case where the diurea as the thickener is the diurea represented by the structural formula (1), the amount of the thickener with respect to the total amount of the base oil and the thickener is preferably 15 to 25 mass %.

When the amount of the thickener is within the above range, this case is suitable for reducing the amount of the base oil separated from the grease G during rotation of the rolling bearing, avoiding an increase in the torque of the rolling bearing, and suppressing oxidation of the grease G due to heat generation of the grease G and degradation of the grease G due to evaporation or separation of the base oil.

In this case, the amount of the thickener with respect to the total amount of the base oil and the thickener is more preferably 18 to 22 mass %.

In the case where the thickener of the grease composition is a diurea, the diurea as the thickener is also preferably a mixture of a diurea represented by the following structural formula (2), a diurea represented by the following structural formula (3), and a diurea represented by the following structural formula (4).

R⁴—NHCONH—R⁵—NHCONH—R⁶ (2),

wherein R⁴ and R⁶ are each independently a functional group represented by —CₙH₂ₙ₊₁ (n is an integer from 6 to 10), and R⁵ is —(CH₂)₆—, —C₆H₃(CH₃)—, or —C₆H₄—CH₂—C₆H₄—.

R⁷—NHCONH—R⁸—NHCONH—R⁹ (3),

wherein R⁷ and R⁹ are each independently a cyclohexyl group or an alkylcyclohexyl group having 1 to 4 alkyl groups having 1 to 4 carbon atoms (the total number of carbon atoms of the alkyl groups is not greater than 4), and R⁸ is —(CH₂)₆—, —C₆H₃(CH₃)—, or —C₄H₄—CH₂—C₆H₄—.

R¹⁰—NHCONH—R¹¹—NHCONH—R¹² (4)

wherein R¹⁰ is a functional group represented by —CₙH₂ₙ₊₁ (n is an integer from 6 to 10), R¹² is a cyclohexyl group or an alkylcyclohexyl group having 1 to 4 alkyl groups having 1 to 4 carbon atoms (the total number of carbon atoms of the alkyl groups is not greater than 4), and R¹¹ is —(CH₂)₆—, —C₆H₃(CH₃)—, or —C₆H₄—CH₂—C₆H₄—.

Here, in the case where R⁵, R⁸, and R¹¹ are each —CH₃(CH₃)—, the phenylene group, bonded with the methyl group at the 1 position, is preferably bonded at the 2 and 4 positions or the 2 and 6 positions. In addition, in the case where R⁵, R⁸, and R¹¹ are each —C₆H₄—CH₂—C₆H₄—, both phenylene groups are preferably bonded at the para position.

R⁵, R⁸, and R¹¹ are each preferably —C₄H₄—CH₂—C₆H₄—.

The diureas represented by the structural formula (2) and the structural formula (4) are an aliphatic diurea and an aliphatic/alicyclic diurea each of which has a short carbon chain length and in which R⁴, R⁶, and R¹⁰ are each independently an alkyl group having 6 to 10 carbon atoms.

Moreover, in the diureas represented by the structural formula (3) and structural formula (4), R⁷, R⁹, and R¹² are each independently a cyclohexyl group or an alkylcyclohexyl group having 1 to 4 alkyl groups having 1 to 4 carbon atoms (the total number of carbon atoms of the alkyl groups is not greater than 4). Therefore, the diureas represented by the structural formula (3) and structural formula (4) are an alicyclic diurea and an aliphatic/alicyclic diurea each of which has no carbon chain or a short carbon chain length.

Here, the alkyl groups having 1 to 4 carbon atoms are each any alkyl group out of a methyl group, an ethyl group, an n-propyl group, an i-propyl group, an n-butyl group, an i-butyl group, and a t-butyl group. Therefore, the alkylcyclohexyl group (the total number of carbon atoms of the alkyl groups is not greater than 4) is an alkylcyclohexyl group in which the alkyl groups having 1 to 4 carbon atoms are bonded at 1 to 4 locations out of the 2 position to 6 position of a cyclohexyl group such that the total number of carbon atoms of the alkyl groups is 1 to 4.

As for the grease composition in which a mixture of such an aliphatic diurea, alicyclic diurea, and aliphatic/alicyclic diurea is used, the aliphatic diurea and the aliphatic/alicyclic diurea have high viscosity-reducing energy, which is one index of channeling properties, and are suitable for torque reduction.

Moreover, as for the grease composition in which the above mixture is used, the alicyclic diurea and the aliphatic/alicyclic diurea suppress softening of the grease due to shearing, so that the grease composition suppresses leak of the grease from the position to be lubricated and is suitable for lengthening the time to the end of the grease life of the rolling bearing in which the grease composition is enclosed.

In the grease composition, in the case where the diurea as the thickener is the mixture of the aliphatic diurea, the alicyclic diurea, and the aliphatic/alicyclic diurea, the proportion of the total amount of R⁴, R⁶, and R¹⁰ (total amount of the alkyl group) to the total amount of R⁴, R⁶, R¹⁰, R⁷, R⁹, and R¹² (total amount of the alkyl group, the cyclohexyl group, and the alkylcyclohexyl group) (hereinafter, also referred to as proportion of the aliphatic functional group) is preferably 50 to 90 mol % based on substance amount (mole).

In this case, as compared to a grease composition in which a diurea as a thickener is composed of only an aliphatic diurea, leak resistance when enclosed in a rolling bearing is very good. In addition, similar to a grease composition in which a diurea as a thickener is composed of only an aliphatic diurea, the grease composition has excellent conductivity, and the torque of the rolling bearing in which the grease composition is enclosed can be reduced.

On the other hand, if the proportion of the aliphatic functional group exceeds 90 mol %, the leak resistance improving effect becomes poor. In addition, if the proportion of the aliphatic functional group is less than 50 mol %, the effect of reducing the torque of the rolling bearing in which the grease composition is enclosed may become poor, or thermal degradation of the grease composition may be likely to occur due to heat generation when the rolling bearing rotates at a high speed.

The proportion of the aliphatic functional group is more preferably 60 to 80 mol %.

The mixture of the diurea represented by the structural formula (2), the diurea represented by the structural formula (3), and the diurea represented by the structural formula (4) is a product produced by reaction between an aliphatic amine and/or an alicyclic amine and a diisocyanate compound.

The aliphatic amine is an aliphatic amine having 6 to 10 carbon atoms, and specific examples of the aliphatic amine include 1-aminohexane, 1-aminoheptane, 1-aminooctane, 1-aminononane, and 1-aminodecane.

Among them, 1-aminooctane is preferable.

Only one of the aliphatic amines may be used, or two or more of the aliphatic amines may be used in combination.

Examples of the alicyclic amine include cyclohexylamine having a cyclohexyl group, and alkylcyclohexylamines in each of which any alkyl group out of a methyl group, an ethyl group, an n-propyl group, an i-propyl group, an n-butyl group, an i-butyl group, and a t-butyl group is bonded at 1 to 4 locations out of the 2 position to 6 position of a cyclohexyl group such that the total number of carbon atoms of the alkyl groups is 1 to 4.

Among the alicyclic amines, cyclohexylamine is preferable.

Only one of the alicyclic amines may be used, or two or more of the alicyclic amines may be used in combination.

Examples of the diisocyanate compound include hexamethylene diisocyanate (HDI), 2,4-toluene diisocyanate (2,4-TDI), 2,6-toluene diisocyanate (2,6-TDI), a mixture of 2,4-TDI and 2,6-TDI, and 4,4′-diphenylmethane diisocyanate (MDI).

In order to obtain the mixture of the diurea represented by the structural formula (2), the diurea represented by the structural formula (3), and the diurea represented by the structural formula (4), the aliphatic amine and the alicyclic amine, and the diisocyanate compound can be reacted under various conditions. The aliphatic amine and the alicyclic amine, and the diisocyanate compound are preferably reacted in the base oil since a mixture of diurea compounds having high uniform dispersibility as the thickener is obtained.

In addition, the reaction between the aliphatic amine and the alicyclic amine, and the diisocyanate compound may be carried out by adding a base oil in which the diisocyanate compound is dissolved, to a base oil in which the aliphatic amine and the alicyclic amine are dissolved, or may be carried out by adding a base oil in which the aliphatic amine and the alicyclic amine are dissolved, to a base oil in which the diisocyanate compound is dissolved.

The temperature and the time in the reaction between the aliphatic amine and the alicyclic amine, and the diisocyanate compound are not particularly limited, and conditions that are the same as the conditions usually used for such a reaction may be used.

The reaction temperature is preferably 150° C. to 170° C. from the viewpoint of solubility and volatility of the aliphatic amine and the alicyclic amine, and the diisocyanate compound.

The reaction time is preferably 0.5 to 2.0 hours from the viewpoint of completing the reaction between the aliphatic amine and the alicyclic amine, and the diisocyanate compound and from the viewpoint of shortening the production time to efficiently produce the grease composition.

In the case where the diurea as the thickener is the mixture of the diurea represented by the structural formula (2), the diurea represented by the structural formula (3), and the diurea represented by the structural formula (4), the amount of the thickener with respect to the total amount of the base oil and the thickener is preferably 10 to 20 mass %.

When the amount of the thickener is within the above range, this case is suitable for reducing the amount of the base oil separated from the grease G during rotation of the rolling bearing, avoiding an increase in the torque of the rolling bearing, and suppressing oxidation of the grease G due to heat generation of the grease G, or degradation of the grease G due to evaporation or separation of the base oil.

In this case, the amount of the thickener with respect to the total amount of the base oil and the thickener is more preferably 13 to 17 mass %.

The conductive additive (A) is a mixture containing sepiolite and bentonite, is an organically modified additive, and is also referred to as an organophilic phyllosilicate.

Sepiolite is a mineral having a chain structure, and bentonite is a mineral having a layered structure or plate-like structure.

In the organophilic phyllosilicate, a three-dimensional network in which sepiolite and bentonite are entangled in a complex manner is formed. In the organophilic phyllosilicate, conductive paths are formed by the three-dimensional network, so that the organophilic phyllosilicate has conductivity. In addition, the organophilic phyllosilicate is organically modified, and thus also has excellent affinity with the base oil.

Therefore, by blending the organophilic phyllosilicate, good conductivity can be imparted to the grease composition.

Moreover, the organophilic phyllosilicate can improve the channeling properties of the grease composition and contribute to reducing the torque of the rolling bearing.

In the organophilic phyllosilicate, both the sepiolite and the bentonite may be organically modified, or either the sepiolite or the bentonite may be organically modified.

In the organophilic phyllosilicate, both the sepiolite and the bentonite are preferably organically modified. This case is more suitable for reducing the torque of the bearing in which the grease composition is enclosed.

The sepiolite or the bentonite being organically modified means that, for example, the sepiolite or the bentonite is treated with a cationic surfactant.

Examples of the cationic surfactant include quaternary ammonium salt type cationic surfactants such as alkyltrimethylammonium chlorides, alkyltrimethylammonium bromides, alkyltrimethylammonium iodides, dialkyldimethylammonium chlorides, dialkyldimethylammonium bromides, dialkyldimethylammonium iodides, and alkylbenzalkonium chlorides; and alkylamine salt type cationic surfactants such as monoalkylamine salts, dialkylamine salts, and trialkylamine salts.

Among them, quaternary ammonium salt type cationic surfactants are preferable.

As the mixture containing the sepiolite and the bentonite and organically modified (organophilic phyllosilicate), a commercially available product can also be used.

Specific examples of the commercially available product include GARAMITE (registered trademark) 1958 (manufactured by BYK), GARAMITE (registered trademark) 2578 (manufactured by BYK), GARAMITE (registered trademark) 7303 (manufactured by BYK), and GARAMITE (registered trademark) 7305 (manufactured by BYK).

The amount of the organophilic phyllosilicate, which is the conductive additive (A), with respect to the total amount of the base oil, the thickener, and the conductive additive (A) is 3 to 10 mass %.

When the amount of the conductive additive (A) is within the above range, the grease composition is a grease composition that suppresses occurrence of electrolytic corrosion when enclosed in a rolling bearing and that is useful for torque reduction.

On the other hand, if the amount of the conductive additive (A) is less than 3 mass %, the conductivity of the grease composition does not become sufficiently high. In addition, when the grease composition is enclosed in a rolling bearing, the torque of the rolling bearing may become large.

Moreover, if the amount of the conductive additive (A) exceeds 10 mass %, the grease composition may become harder, and the torque of a rolling bearing in which the grease composition is enclosed may become excessively large.

The amount of the organophilic phyllosilicate with respect to the total amount of the base oil, the thickener, and the conductive additive (A) is preferably 3 to 7 mass %.

The grease composition preferably contains a rust preventive and/or an antioxidant in addition to the conductive additive (A). In this case, the lubrication life of the grease composition can be further improved.

As other additives, the grease composition may further contain, for example, an extreme pressure agent, an oily agent, an anti-wear agent, a dye, a hue stabilizer, a thickening agent, a structure stabilizer, a metal deactivator, a viscosity index improver, etc.

Preferably, the grease composition does not contain carbon black. This is for avoiding a situation in which a member around the rolling bearing becomes stained in black when the grease composition leaks from the rolling bearing.

Next, a method for producing the grease composition will be described.

The grease composition can be produced, for example, by initially preparing a base grease including the base oil and the thickener, then putting the conductive additive (A) and optional components to be contained as necessary, into the obtained base grease, and agitating and mixing each component using a rotation-revolution mixer or the like.

According to the embodiment described so far, as the grease composition forming the grease G enclosed in the ball bearing 1, a grease composition containing the above-described conductive additive (A) in addition to the trimellitic acid ester as a base oil and the thickener is used. By using such a grease composition, occurrence of electrolytic corrosion can be suppressed in the ball bearing 1 in which the grease G is enclosed.

Moreover, by using the grease G, the torque of the ball bearing 1 can be reduced.

The embodiment of the invention of the present disclosure is not limited to the above embodiment, and may be another embodiment.

For example, an embodiment of the rolling bearing according to the present disclosure may be a rolling bearing, other than a ball bearing in which rolling elements other than balls are used, such as a roller bearing in which a grease composed of the grease composition according to the present disclosure is enclosed.

### EXAMPLES

Hereinafter, the present invention will be described in further detail based on examples, but the present invention is not limited to these examples.

Here, a plurality of grease compositions were prepared, and the characteristics of each grease composition were evaluated. The blending formula and the evaluation results of each grease composition are shown in Table 1.

### (Preparation of Base Grease A)

A grease composition containing a trimellitic acid triester as a base oil and a diurea as a thickener was prepared as a base grease A through the following steps.

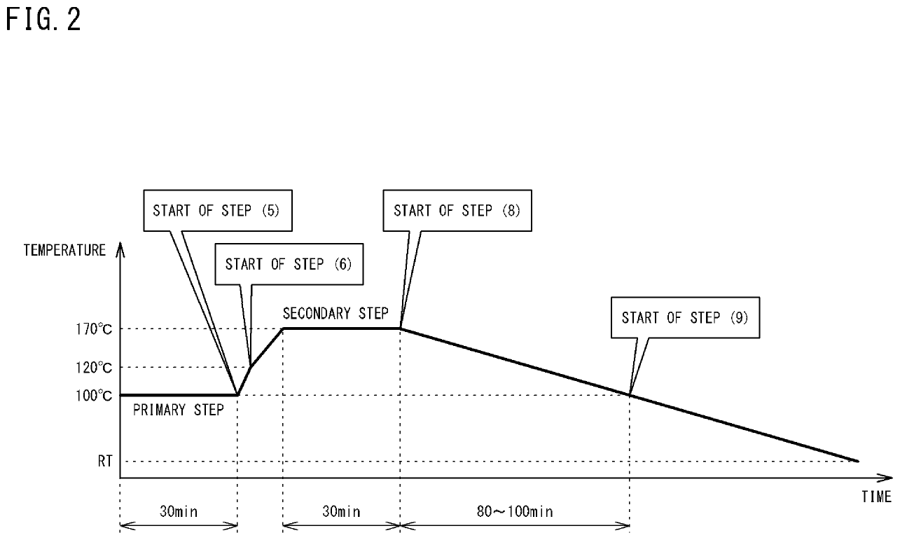

FIG. 2 is a diagram for illustrating a base grease preparation step.

(1) Tri-n-alkyl trimellitate (C8, C10)(manufactured by Kao Corporation, (trade name) TRIMEX N-08), which is one kind of trimellitic acid triester, is used as a base oil, and the base oil is heated to 100° C.

(2) The base oil, 1-aminooctane, and 4,4′-diphenylmethane diisocyanate (MDI) are weighed.

(3) Half of the amount of the base oil (100° C.) and MDI are put into a stainless steel vessel A, and the mixture is agitated at 100° C. for 30 minutes.

(4) The remaining half amount of the base oil (100° C.) and 1-aminooctane are put into another stainless steel vessel B, and the mixture is agitated at 100° C. for 30 minutes.

The above steps (3) and (4) are referred to as a primary step.

(5) The amine solution in the stainless steel vessel B is dropped into the stainless steel vessel A to be gradually put into the isocyanate solution. At this time, the solution temperature rises by about 20° C. due to the heat of reaction.

(6) After confirming that the total amount of the amine solution in the stainless steel vessel B is put into the stainless steel vessel A, the temperature is increased to 170° C.

(7) The solution is agitated while being heated, and the temperature is held at 170° C. for 30 minutes. This step (7) is referred to as a secondary step.

(8) The heating is stopped, and the solution is naturally cooled while being agitated, and is cooled to 100° C.

(9) After confirming that the temperature has reached 100° C. or lower, the agitation is stopped, and the solution is naturally cooled as it is until reaching normal temperature.

(10) Homogenization treatment is performed using a three roll mill. The treatment conditions at this time are as follows.

Gap between rolls: 50 μm

Pressure between rolls: 1 MPa

Rotation speed: 200 min⁻¹

Treatment temperature: 25° C.

Through such steps (1) to (10), the base grease A containing 20 mass % of the thickener and 80 mass % of the base oil was prepared.

In addition, the base grease A was evaluated as described later, as a grease composition of Comparative Example 1.

The thickener of the produced base grease A is a diurea having the following structural formula (a).

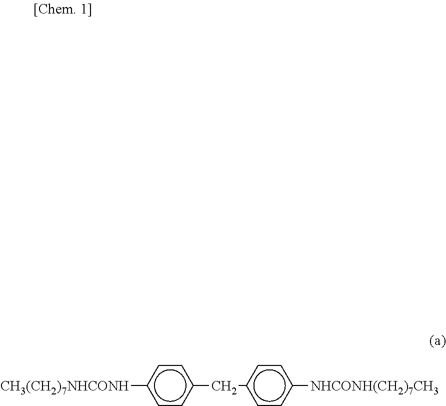

### Example 1

A grease composition was prepared by mixing 95.00 parts by mass of the base grease A and 5.00 parts by mass of an organophilic phyllosilicate by the following method.

The organophilic phyllosilicate was mixed with the base grease A using a rotation-revolution mixer under the conditions of rotation speed: 2000 min⁻¹ and time: 3 minutes.

Here, “GARAMITE (registered trademark) 7303, manufactured by BYK” was used as the organophilic phyllosilicate.

### Example 2

A grease composition was prepared in the same manner as Example 1, except that the blending amounts of the base grease A and the organophilic phyllosilicate were changed to 90.00 parts by mass and 10.00 parts by mass, respectively.

### Example 3

(A) First, a grease composition containing a trimellitic acid triester as a base oil and a mixture of three kinds of diureas as a thickener was prepared as a base grease B through the following steps (see FIG. 2).

(1) Tri-n-alkyl trimellitate (C8, C10)(manufactured by Kao Corporation, (trade name) TRIMEX N-08), which is one kind of trimellitic acid triester, is used as a base oil, and the base oil is heated to 100° C.

(2) The base oil, 1-aminooctane, cyclohexylamine, and 4,4′-diphenylmethane diisocyanate (MDI) are weighed. Here, 1-aminooctane and cyclohexylamine are weighed such that 1-aminooctane: cyclohexylamine=7:3 in molar ratio.

(3) Half of the amount of the base oil (100° C.) and MDI are put into a stainless steel vessel C, and the mixture is agitated at 100° C. for 30 minutes.

(4) The remaining half amount of the base oil (100° C.), 1-aminooctane, and cyclohexylamine are put into another stainless steel vessel D, and the mixture is agitated at 100° C. for 30 minutes.

The above steps (3) and (4) are referred to as a primary step.

(5) The amine solution in the stainless steel vessel D is dropped into the stainless steel vessel C to be gradually put into the isocyanate solution. At this time, the solution temperature rises by about 20° C. due to the heat of reaction.

(6) After confirming that the total amount of the amine solution in the stainless steel vessel D is put into the stainless steel vessel C, the temperature is increased to 170° C.

(7) The solution is agitated while being heated, and the temperature is held at 170° C. for 30 minutes. This step (7) is referred to as a secondary step.

(8) The heating is stopped, and the solution is naturally cooled while being agitated, and is cooled to 100° C.

(9) After confirming that the temperature has reached 100° C. or lower, the agitation is stopped, and the solution is naturally cooled as it is until reaching normal temperature.

(10) Homogenization treatment is performed using a three roll mill. The treatment conditions at this time are as follows.

Gap between rolls: 50 μm

Pressure between rolls: 1 MPa

Rotation speed: 200 min⁻¹

Treatment temperature: 25° C.

Through such steps (1) to (10), the base grease B containing 15 mass % of the thickener and 85 mass % of the base oil was prepared.

The thickener of the produced base grease B is a mixture of an aliphatic diurea having the following structural formula (a), an alicyclic diurea having the following structural formula (b), and an aliphatic/alicyclic diurea having the following structural formula (c).

In the mixture of the diureas, the proportion of the total amount of the two octyl groups in the structural formula (a) and the octyl group in the structural formula (c) to the total amount of the two octyl groups in the structural formula (a), the octyl group in the structural formula (c), the two cyclohexyl groups in the structural formula (b), and the cyclohexyl group in the structural formula (c) is 70 mol % based on substance amount.

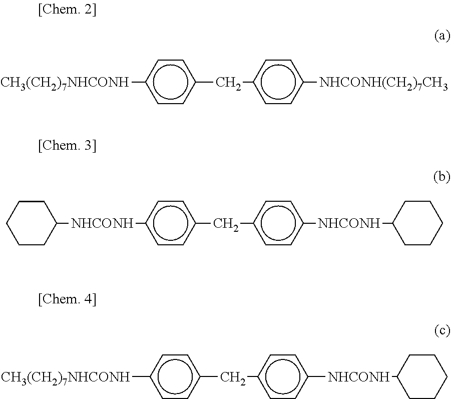

(B) Next, a grease composition was prepared by mixing 95.00 parts by mass of the base grease B and 5.00 parts by mass of an organophilic phyllosilicate (GARAMITE (registered trademark) 7303) by the following method.

The organophilic phyllosilicate was mixed with the base grease B using a rotation-revolution mixer under the conditions of rotation speed: 2000 min⁻¹ and time: 3 minutes.

### Comparative Example 1

The base grease A was used as a grease composition of this comparative example.

### Comparative Example 2

A grease composition was prepared in the same manner as Example 1, except that the blending amounts of the base grease A and the organophilic phyllosilicate were changed to 98.00 parts by mass and 2.00 parts by mass, respectively.

### Comparative Example 3

A grease composition was prepared in the same manner as Example 2, except that carbon black “#3050B, manufactured by Mitsubishi Chemical Corporation” was blended instead of the organophilic phyllosilicate.

### Comparative Example 4

(A) First, a grease composition containing poly-α-olefin as a base oil and a diurea as a thickener was prepared as a base grease C through the following steps (see FIG. 2).

(1) PAO6 (manufactured by INEOS Oligomers, (trade name) Durasyn 166 polyalphaolefin, kinetic viscosity (40° C.): 29 to 33 mm²/s), which is one kind of poly-α-olefin, is used as a base oil, and the base oil is heated to 100° C.

(2) The base oil, p-toluidine, and 4,4′-diphenylmethane diisocyanate (MDI) are weighed.

(3) Half of the amount of the base oil (100° C.) and MDI are put into a stainless steel vessel E, and the mixture is agitated at 100° C. for 30 minutes.

(4) The remaining half amount of the base oil (100° C.) and p-toluidine are put into another stainless steel vessel F, and the mixture is agitated at 100° C. for 30 minutes.

The above steps (3) and (4) are referred to as a primary step.

(5) The amine solution in the stainless steel vessel F is dropped into the stainless steel vessel E to be gradually put into the isocyanate solution. At this time, the solution temperature rises by about 20° C. due to the heat of reaction.

(6) After confirming that the total amount of the amine solution in the stainless steel vessel F is put into the stainless steel vessel E, the temperature is increased to 170° C.

(7) The solution is agitated while being heated, and the temperature is held at 170° C. for 30 minutes. This step (7) is referred to as a secondary step.

(8) The heating is stopped, and the solution is naturally cooled while being agitated, and is cooled to 100° C.

(9) After confirming that the temperature has reached 100° C. or lower, the agitation is stopped, and the solution is naturally cooled as it is until reaching normal temperature.

(10) Homogenization treatment is performed using a three roll mill. The treatment conditions at this time are as follows.

Gap between rolls: 50 μm

Pressure between rolls: 1 MPa

Rotation speed: 200 min⁻¹

Treatment temperature: 25° C.

Through such steps (1) to (10), the grease composition was prepared.

The thickener of the produced base grease C is an aromatic diurea.

(B) Next, a grease composition was prepared by mixing 90.00 pars by mass of the base grease C and 10.00 parts by mass of an organophilic phyllosilicate (GARAMITE (registered trademark) 7303) by the following method.

The organophilic phyllosilicate was mixed with the base grease C using a rotation-revolution mixer under the conditions of rotation speed: 2000 min⁻¹ and time: 3 minutes.

(Evaluation of Grease Compositions)

The grease compositions prepared in Examples 1 to 3 and Comparative Examples 1 to 4 were evaluated. The results are shown in Table 1.

TABLE 1

| | | | | | | Comp. | Comp. | Comp. | Comp. |
|---|---|---|---|---|---|---|---|---|---|
| | | | Ex. 1 | Ex. 2 | Ex. 3 | Ex. 1 | Ex. 2 | Ex. 3 | Ex. 4 |
| Base oil | Trimellitic acid ester | mass % | 76.00 | 72.00 | 80.75 | 80.00 | 78.40 | 72.00 | — |
| | Poly-α-olefin | mass % | — | — | — | — | — | — | 65.00 |
| Thickener | Aliphatic diurea | mass % | 19.00 | 18.00 | — | 20.00 | 19.60 | 18.00 | — |
| | Mixture of aliphatic diurea, | mass % | — | — | 14.25 | — | — | — | — |
| | alicyclic diurea, and | | | | | | | | |
| | aliphatic/alicyclic diurea | | | | | | | | |
| | (aliphatic:alicyclic = 7:3 | | | | | | | | |
| | (molar ratio)) | | | | | | | | |
| | Aromatic diurea | mass % | — | — | — | — | — | — | 25.00 |
| Conductive | Organophilic phyllosilicate | mass % | 5.00 | 10.00 | 5.00 | 0.00 | 2.00 | 0.00 | 10.00 |
| additive | Carbon black | mass % | 0.00 | 0.00 | 0.00 | 0.00 | 0.00 | 10.00 | 0.00 |
| Evaluation | Volume resistivity | Ω · cm | 4.8 × 10⁶ | 6.1 × 10⁶ | 6.8 × 10⁶ | 5.6 × 10⁹ | 3.2 × 10⁷ | 2.7 × 10⁸ | 2.0 × 10⁹ |
| | Lost energy (derived from | J | 6.5 | 14.0 | 8.4 | 10.8 | 15.2 | 16.3 | 11.9 |
| | rotation torque) | | | | | | | | |
| | Grease life | h | 11 | — | 133 | — | — | — | — |

The method for each evaluation shown in Table 1 is as follows.

(1) Measurement of Volume Resistivity

The volume resistivity of each of the grease compositions prepared in Examples and Comparative Examples was measured by the following method.

“ADCMT liquid resistance sample box 12707” was used as an electrode, and “ADCMT digital ultra-high resistance/micro ammeter R8340A” was used as a measurement device, 0.8 ml of a grease composition as a sample was put in the liquid resistance sample box, and the volume resistivity (Ω·cm) of the grease composition was measured. The measurement conditions are as shown in Table 2.

TABLE 2

| Item | Condition | |
|---|---|---|
| Measurement device | ADCMT digital ultra-high resistance/micro | |
| | ammeter R8340A | |
| Electrode | ADCMT liquid resistance sample box 12707 | |
| Amount of grease | 0.8 | ml |
| Sample thickness | 1000 | μm |
| Measurement voltage | 0.01 | V |

| | |
|---|---|
| Measurement gain | ×10000 |
| Presence/absence of | Presence |
| guard electrode | |

(2) Measurement of Lost Energy (Derived from Rotation Torque)

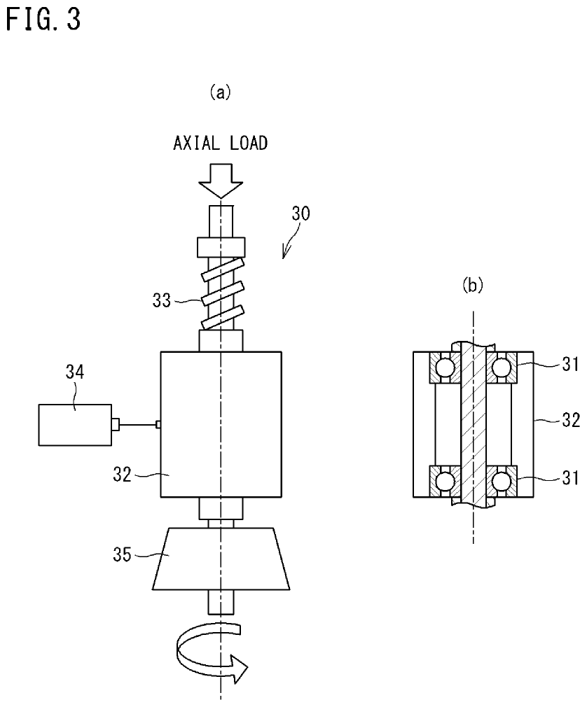

The lost energy (derived from rotation torque) of each of the grease compositions prepared in Examples and Comparative Examples was measured using a bearing rotation torque measurement testing machine (see FIG. 3(a) and FIG. 3(b)) according to the conditions in Table 3 below. FIG. 3(a) is a schematic diagram of a bearing rotation torque measurement testing machine 30, and FIG. 3(b) is a cross-sectional view of a housing 32 of the testing machine having test bearings 31 incorporated therein.

Here, each of the grease compositions prepared in Examples and Comparative Examples was enclosed in “6202 2RUCM FGP0S00”, which are the test bearings 31, such that the grease composition occupied 35 vol % of the volume of a space obtained by excluding balls and a retainer from a space surrounded by an inner ring, an outer ring, and seals.

Two test bearings 31 were incorporated in the housing 32 of the bearing rotation torque measurement testing machine 30 as shown in FIG. 3(b), and a test was performed as follows. An axial load applied via a spring 33 was set to a constant load of 44 N, the inner rings were preliminarily rotated at 1800 min⁻¹ at room temperature for 60 seconds, then the test bearings 31 were allowed to stand for 60 seconds, and the inner rings were rotated at 1800 min⁻¹. The test time was 1800 seconds. The rotation torque was calculated by measuring the tangential force acting on the housing 32 with a load detection load cell 34 and multiplying the tangential force by the outer diameter dimension of the housing 32. In FIG. 3, reference sign 35 denotes a spindle.

TABLE 3

| Item | Condition | |
|---|---|---|
| Test bearing | 6202 2RUCM FGP0S00 | |
| | (main dimensions: inner diameter 15 mm × | |
| | outer diameter 35 mm × width 11 mm) | |
| Grease enclosed | Amount equivalent to 35% in space | |
| amount | volume ratio | |
| Axial load | 44N | |
| Surface pressure | 0.93 | GPa |
| (calculation) | | |
| Rotation speed | 1800 | min⁻¹ |

| | |
|---|---|
| Ambient temperature | 25° C. (room temperature) |
| Test time | 1,800 s (preliminary rotation: 60 s) |
| Measurement item | Lost energy (time integral value during total |
| | test time) |
| Testing machine | Bearing rotation torque measurement testing |
| | machine |

Thereafter, the measured rotation torque was time-integrated to calculate the energy lost during bearing rotation. In this evaluation, this energy was defined as lost energy (derived from rotation torque).

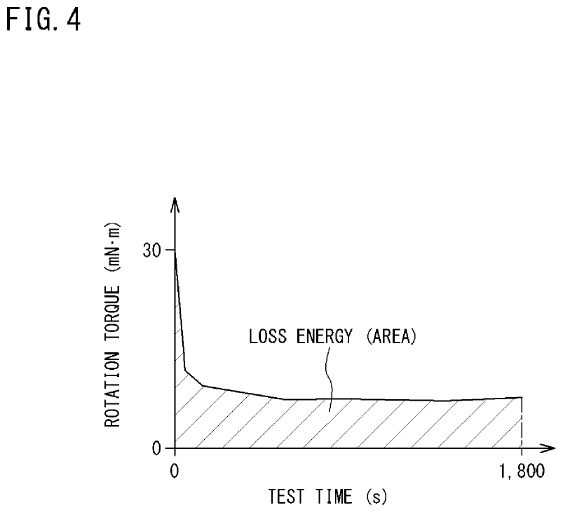

The time change of the rotation torque can be plotted as shown in FIG. 4, and the area of a hatched portion in FIG. 4 corresponds to the above lost energy. In the above lost energy evaluation, lower lost energy means that the grease composition is a channeling type grease composition that is more unlikely to flow onto a rolling surface (portion, of a raceway surface, with which the balls are in contact) again after being removed from the rolling surface.

FIG. 4 does not reflect the actual test results of any of Examples and Comparative Examples, but is an example for illustrating the relationship between rotation torque and the above lost energy.

(3) Measurement of Grease Life

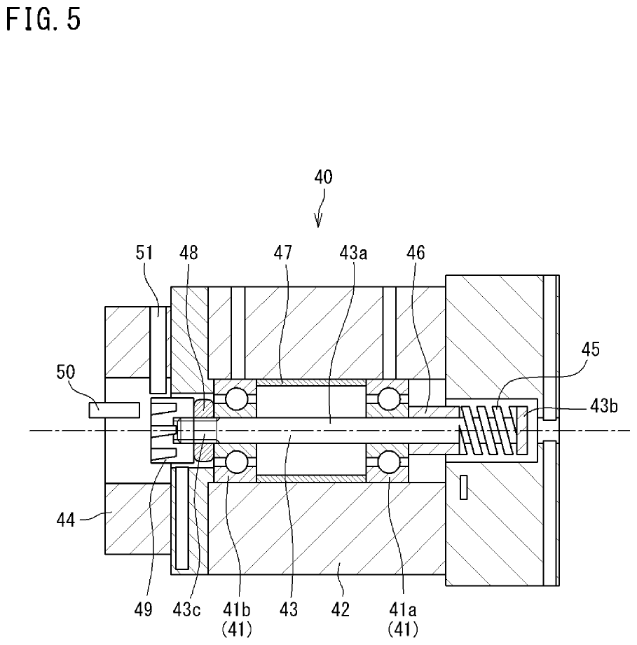

The grease life of each of the grease compositions prepared in Example 1 and Example 3 was measured using a bearing grease life measurement testing machine (see FIG. 5) according to the conditions in Table 4 below. FIG. 5 is a schematic diagram of a bearing grease life measurement testing machine 40 having test bearings 41 incorporated therein.

The bearing grease life measurement testing machine 40 includes a housing 42, a shaft 43 having a shaft body 43a, a flange 43b at one shaft end, a male screw 43c at the other shaft end, a lid 44, a load spring 45, a first spacer 46, a second spacer 47, a bearing nut 48, a driving air turbine 49, and a rotation speed detection sensor 50.

In the bearing grease life measurement testing machine 40, the load spring 45 is brought into contact with the flange 43b at the one shaft end of the shaft 43, the first spacer 46 is brought into contact with the load spring 45, the inner ring of a first test bearing 41a is brought into contact with the first spacer 46, the second spacer 47 is brought into contact with the outer ring of the first test bearing 41a, the outer ring of a second test bearing 41b is brought into contact with the second spacer 47, and the bearing nut 48 is brought into contact with the inner ring of the second test bearing 41b, and these components are mounted on the outer circumference of the shaft body 43a. By screwing the bearing nut 48 to the male screw 43c at the other shaft end, the load spring 45 is contracted to apply an axial load to the first test bearing 41a and the second test bearing 41b. The driving air turbine 49 is attached to the tip of the male screw 43c at the other shaft end. Furthermore, an assembly of the shaft 43, the load spring 45, the first spacer 46, the first test bearing 41a, the second spacer 47, the second test bearing 41b, the bearing nut 48, and the driving air turbine 49 is inserted into the housing 42, and the lid 44 is mounted on the housing 42. The lid 44 has an air inlet 51 formed at a position corresponding to the air turbine 49 in the axial direction. By blowing high-pressure air from the air inlet 51 to the air turbine 49, the inner ring of the first test bearing 41a and the inner ring of the second test bearing 41b which are fixed to the shaft 43 are rotated relative to the outer ring of the first test bearing 41a and the outer ring of the second test bearing 41b which are fixed to the housing 42. The rotation speed detection sensor 50 fixed to the lid 44 measures the rotation speed of the air turbine 49 with respect to the housing 42.

Here, each of the grease compositions prepared in Example 1 and Example 3 was enclosed in “608-2RU (resin retainer is used)”, which are the first test bearing 41a and the second test bearing 41b, such that the grease composition occupied 20 vol % of the volume of a space obtained by excluding balls and a retainer from a space surrounded by an inner ring, an outer ring, and seals.

TABLE 4

| Item | Condition |
|---|---|
| Test bearing | 608-2RU |
| | (main dimensions: inner diameter 8 mm × outer |
| | diameter 22 mm × width 7 mm) |
| Grease enclosed | Amount equivalent to 20% in space volume ratio |
| amount | |
| Axial load | 20N |
| Rotation speed | 100000 min⁻¹ |
| Ambient temperature | 25° C. (room temperature) |
| Measurement item | Time until locking of test bearing due to |
| | degradation of grease |
| Testing machine | Bearing grease life measurement testing machine |

In the case of this test, the grease life was ended by the test bearing causing poor lubrication due to the leak of the grease from the space surrounded by the inner ring, the outer ring, and the seals to the external space. In this test, the time (h) until locking of the test bearing was measured. This test revealed that the grease composition containing a thickener which is a mixture of an aliphatic diurea, an alicyclic diurea, and an aliphatic/alicyclic diurea is less likely to leak from the test bearing than the grease composition containing a thickener that is an aliphatic urea.

As shown in the results of Examples and Comparative Examples, it has been found that the grease composition according to the present disclosure has good conductivity and thus can suppress occurrence of electrolytic corrosion in a rolling bearing and the grease composition is also useful for reducing the torque of the rolling bearing.

### REFERENCE SIGNS LIST

1 ball bearing
2 inner ring
3 outer ring
4 ball
5 retainer
6 seal
7 region
30 bearing rotation torque measurement testing machine
31, 41 test bearing
40 bearing grease life measurement testing machine
G grease

1. A grease composition containing a base oil, a thickener, and a conductive additive (A), wherein
the base oil is a trimellitic acid ester,
the conductive additive (A) is a mixture containing sepiolite and bentonite and is an organically modified additive, and
an amount of the conductive additive (A) with respect to a total amount of the base oil, the thickener, and the conductive additive (A) is 3 to 10 mass %.

2. The grease composition according to claim 1, wherein a proportion of the thickener to a total mass of the base oil and the thickener is 10 to 25 mass %.

3. The grease composition according to claim 1 or 2, wherein the thickener is a diurea represented by the following structural formula (1),
R¹—NHCONH—R²—NHCONH—R³ (1),
wherein R¹ and R³ are each independently a functional group represented by —CₙH₂ₙ₊₁ (n is an integer from 6 to 10), and R² is —(CH₂)₆—, —C₆H₃(CH₃)—, or —C₆H₄—CH₂—C₆H₄—.

4. The grease composition according to claim 3, wherein the proportion of the thickener to the total mass of the base oil and the thickener is 15 to 25 mass %.

5. The grease composition according to claim 1 or 2, wherein the thickener is a mixture of a diurea represented by the following structural formula (2), a diurea represented by the following structural formula (3), and a diurea represented by the following structural formula (4),
R⁴—NHCONH—R⁵—NHCONH—R⁶ (2),
wherein R⁴ and R⁶ are each independently a functional group represented by —CₙH₂ₙ₊₁ (n is an integer from 6 to 10), and R⁵ is —(CH₂)₆—, —C₆H₃(CH₃)—, or —C₆H₄—CH₂—C₆H₄—,
R⁷—NHCONH—R⁸—NHCONH—R⁹ (3),
wherein R⁷ and R⁹ are each independently a cyclohexyl group or an alkylcyclohexyl group having 1 to 4 alkyl groups having 1 to 4 carbon atoms (the total number of carbon atoms of the alkyl groups is not greater than 4), and R⁸ is —(CH₂)₆—, —C₆H₃(CH₃)—, or —C₆H₄—CH₂—C₆H₄—,
R¹⁰—NHCONH—R¹¹—NHCONH—R¹² (4),
wherein R¹⁰ is a functional group represented by —CₙH₂ₙ₊₁ (n is an integer from 6 to 10), R¹² is a cyclohexyl group or an alkylcyclohexyl group having 1 to 4 alkyl groups having 1 to 4 carbon atoms (the total number of carbon atoms of the alkyl groups is not greater than 4), and R¹¹ is —(CH₂)₆—, —C₆H₃(CH₃)—, or —C₆H₄—CH₂—C₆H₄—.

6. The grease composition according to claim 5, wherein a proportion of a total amount of R⁴, R⁶, and R¹⁰ to a total amount of R⁴, R⁶, R¹⁰, R⁷, R⁹, and R¹² in the thickener is 50 to 90 mol %.

7. The grease composition according to claim 5 or 6, wherein the proportion of the thickener to the total mass of the base oil and the thickener is 10 to 20 mass %.

8. The grease composition according to any one of claims 1 to 7, further containing at least a rust preventive or an antioxidant.

9. A rolling bearing in which the grease composition according to any one of claims 1 to 8 is enclosed.
